(19) United States
(12) Patent Application Publication
(10) Pub. No.: US 2015/0193596 A1
(43) Pub. Date: Jul. 9, 2015

(54) METHOD FOR CONDUCTING CLINICAL TRIALS BASED ON SUBSTANTIALLY CONTINUOUS MONITORING OF OBJECTIVE QUALITY OF LIFE FUNCTIONS

(71) Applicant: OREGON HEALTH & SCIENCE UNIVERSITY, Portland, OR (US)

(72) Inventors: Jeffrey Kaye, Portland, OR (US); Daniel Austin, Portland, OR (US); Hiroko Dodge, Portland, OR (US); Tamara Hayes, Portland, OR (US)

(21) Appl. No.: 14/581,841

(22) Filed: Dec. 23, 2014

Related U.S. Application Data
(60) Provisional application No. 61/923,565, filed on Jan. 3, 2014.

(51) Int. Cl. G06F 19/00

(52) U.S. Cl. CPC G06F 19/36

(57) ABSTRACT

A system and method for conducting a clinical trial of a medical treatment of human patients. The system uses an array of sensors in the patient's home for substantially continuously monitoring one or more objective functions of the patient. The monitored objective functions of the patient are compared against a baseline set of data for the monitored objective functions for the patient or a set of patients. The comparison includes detecting a trend of deviation between the one or more monitored objective functions of the patient and the baseline set of data. The trend of deviation can be correlated with an application or nonapplication of the medical treatment to the patient.

### CROSS REFERENCE TO RELATED APPLICATIONS

This application claims the benefit of copending U.S. provisional patent application Ser. No. 61/923,565, filed Jan. 3, 2014, incorporated by reference herein.

### BACKGROUND OF THE INVENTION

Hundreds of millions of people world-wide are tragically affected by the major diseases and conditions of our time: Alzheimer's, cardiovascular disease, cancer, chronic pain, etc. The search for effective treatments of these ailments is an active trillion dollar global enterprise. Unfortunately, despite the identification of thousands of potential treatments for each of these conditions, the process for identifying from a multitude of candidate treatments, the very few that may eventually prove safe and effective is highly inefficient, lengthy and very costly. Currently, it takes over a decade or more to complete testing and verify suitability of drugs for patient use; but only 8 of 100 drugs that enter clinical testing make it to market. Each failed drug costs $4-11 billion to fully develop. Thus pharmaceutical companies are spending hundreds of billions of dollars to bring just a few drugs each year into clinical use. This has led leaders in this field such as Susan Desmond-Hellmann, the chancellor at UCSF and former head of development at industry legend Genentech, where she led the testing of cancer drugs like Herceptin and Avastin to conclude that “This is crazy. For sure it's not sustainable,”[Forbes, 2013].

The current untenable model of drug development involves an incremental process of passing from early phase I studies focused on safety followed by phase II and III studies focused increasingly on confirming not only safety, but ultimately efficacy. The critical weak link in this process is the inability to determine whether there is a signal for efficacy early in development before a drug enters successively larger and more expensive phase III clinical trials. The cost of this leap of faith from phase I is typically an $80+ million dollar gamble. The result: thousands of compounds await testing or enter into early trials only to be found ineffective in late phase III studies—a tremendous loss of time, money, and lives. Importantly, this process has not fundamentally changed for decades. A major reason for this is that the underlying methods used to determine clinical efficacy continue to rely on subjective self-report measures or brief tests that are obtained in a clinic on an infrequent basis. This approach to assessments is prone to inherent measurement variability and does not represent day-to-day function in the real world. This leads to the requirement of large sample sizes, multiple study clinics and long observation periods to determine if a treatment works.

### SUMMARY OF THE INVENTION

We no longer need to rely on this limiting methodology. We have created an assessment platform or system that allows functionally relevant outcomes to be objectively and continuously captured in a person's home with minimal to no intrusion in everyday activities. This is accomplished by using inexpensive activity sensors placed in the home along with other data capture technologies (e.g., electronic medication pillboxes, computer and phone use assessment). The resulting objective, high frequency data generated is readily aggregated into functional meaningful outcomes (mobility, cognition, sleep, medication adherence, vital signs, etc.). Most importantly, this approach transforms the requirements of clinical trials, reducing the number of volunteers needed and/or the time to get an answer several-fold. Trial requirements go from the current thousands needed to a hundred or even fewer participants. Uniquely, individual predictions rather than the current group mean data outcome comparisons are now possible. This immediately translates to being able to test many more promising treatments and to making much more informed decisions as to whether treatments are worth pursuing or not to more expensive later stage clinical trials.

The assessment platform or system captures short- and long-term changes in behavior as people go about their daily activities using unobtrusive ambient sensors (e.g., passive IR motion activity sensors, magnetic contact sensors, computer based activities) distributed throughout the home. This continuous stream of data is translated into objective functional measures (i.e., activity levels within specific living domains, walking speed, time out of home, etc.) through statistical models. These objective metrics include sleep movement patterns, total activity levels, walking speed, dwell and transition times in or to various rooms (e.g., bathroom, bedroom), computer usage, medication taking behavior and outings information.

A method for conducting a clinical trial of a medical treatment with respect to one or more human patients, includes substantially continuously monitoring one or more objective functions of the patient or patients. The monitored objective functions of each patient are compared against a baseline set of monitored data of the objective functions for the patient or a set of patients. Uniquely, this baseline is much more stable than the conventional single “baseline” measure as it can be composed of many samples of data over a well-defined baseline period of behavior or activity (e.g., a week to several months) depending on the relevant real-life comparison required overtime. This comparison can be used to detect a trend of deviation between the one or more monitored objective functions of the patient and the baseline set of data. The trend of deviation can then be correlated with an application or nonapplication of the medical treatment (e.g., a medication or clinical intervention) with respect to each patient. The objective functions can include objective physical functions or objective behavioral functions of the patient, or preferably both.

The clinical trial can be applied to a sample set of a plurality of patients, having a size selected based on intra-individual distributions of daily activities based on the substantially continuously monitored objective physical functions of the patient over a sample period of time. The sample set size can be selected based in part on a treatment effect size to be measured, and can be an order of magnitude less than a sample set size derived from a series of monthly to annual measures of patient-subjective reports of patient functions.

In the next year, thousands of new clinical trials will be considered for human study. Millions of patient volunteers and their families will be needed to determine if these potential new therapies are safe and effective. With the assessment platform in place and using the foregoing method, we would greatly reduce costs to industry and most notably expose at least half as many people to the risks and lost opportunities inherent in current clinical trial development. Most importantly we would increase our chances to have more effective therapies.

The foregoing and other objects, features and advantages of the invention will become more readily apparent from the following detailed description of a preferred embodiment of the invention which proceeds with reference to the accompanying drawings.

### BRIEF DESCRIPTION OF THE DRAWINGS

FIG. 1 is a diagram of capability clusters of different aspects of quality of life measurements that can be objectively assessed in connection with the present invention.

FIG. 2 is a diagram of a distributed community model of in-home functional assessment of patients.

FIG. 3 is a data flow diagram showing acquisition of raw sensor data, direct assessment, top-level inferences and change detection for key functional domains/capability clusters that can be objectively assessed on a near-continuous basis in connection with the present invention.

FIG. 4 is a block diagram of a hardware system for implementing the present invention.

FIG. 5 is a 24/7 spiral plot showing daily patterns over an 8-week interval of objective functions of a patient monitored substantially continuously around the clock, the plot including a color key indicating patient location and activities and captions indicating and describing features of the plot.

FIG. 6 is a plot similar to FIG. 5 showing a time interval in which the sensors detected changes in activities indicated in an oval which were associated with a norovirus outbreak.

FIG. 7 shows two plots like FIG. 6 for a particular patient P taken over two different time durations, the left plot showing normal or baseline activities in a first 8-week period and the second plot for patient P during an 8-week interval about 18 months later, at which time the patient was diagnosed with Parkinson's disease.

FIG. 8 is a plot similar to those of FIG. 7 showing a time interval after commencement of treatment of patient P for Parkinson's disease.

FIG. 9 shows the activity plots of FIGS. 7 and 8 annotated with indications of significant features and changes in the patient's functions corresponding to changes from healthy to ill and back to relative health with treatment.

FIG. 10 is a plot of in-home walking speed of patient P compared to peer group normal mean in-home walking speed and to patient P's walking speed at in-person clinical visits.

FIG. 11 is a plot of in-home computer usage of patient P compared to peer group normal mean in-home computer usage over time.

FIG. 12 is a plot of mean sleep time of patient P compared to peer group mean sleep time.

FIG. 13 are graphs illustrating two types or classes of change that are analyzed in the present invention, the first graph showing changes in mean or median measured function and the second graph showing change of variance of the measured function relative to the mean.

FIG. 14 is a graph of medication adherence as a measure of differences in cognitive function.

FIG. 15 is a graph of walking speed as a measure of change in mild cognitive impairment.

FIG. 16 is a graph of home personal computer usage as a measure of change in mild cognitive impairment.

FIG. 17 shows two graphs for two hypothetical persons comparing their walking speeds and showing their respective variances in walking speed at a first standard deviation and FIG. 17A is an example of real walking measurements comparing two patients.

FIG. 18 is a radar graph in which each radial spoke represents a different objectively measured assessment of a person's activities or capabilities, further showing examples of how these measures are affected by various drugs.

FIG. 19 is a table showing an example of how in-home continuous measures of objective activities reduce sample sizes needed to assess mild cognitive impairment.

FIG. 20 is a block diagram comparing the conventional method for conducting clinical trials with the method of the present invention.

### DETAILED DESCRIPTION

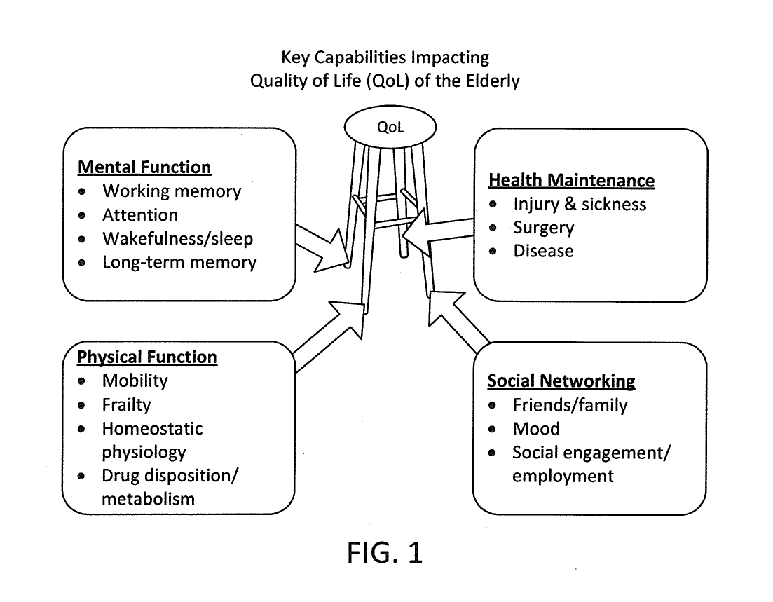

FIG. 1 is a diagram of capability clusters of different aspects of quality of life measurements that can be objectively assessed in connection with the present invention. FIG. 1 illustrates different aspects of a patient's activities that are related to quality-of-life. Many of these can be monitored and measured objectively and used in the present invention.

In addition to comparing changes within a person (against a baseline), we can compare changes between control and treatment groups. In addition to objective physical functions, we have objective “behavioral” measures that are associated with at least cognitive and emotional function in addition to physical function (e.g., sleep, time-out-of-house, computer use, time spent in bathroom or number of bathroom trips, etc.).

Besides detecting trends in functional measures (e.g., walking speed or computer use), we can detect changes in variability (e.g., changes in the size of the change around a trend in walking speed or computer use) and changes in functional behavioral patterns (e.g., going to bed and waking up earlier or later, or leaving the home in afternoon instead of the morning). All of these things can be correlated with application or nonapplication of medical treatment.

Some key ideas are that the present method allows for detection of change due to a drug response with fewer participants and/or less monitoring time per person to detect potential changes from a drug/medical treatment. The method also allows for detailed understanding of the effects of the time course of a drug (instead of just average effects across a person and/or a population as with typical trials). Further, changes in the functional measures may be important for drug label claims in addition to the desired benefit (e.g., drug XX reduces pain and improves walking speed and sleep quality).

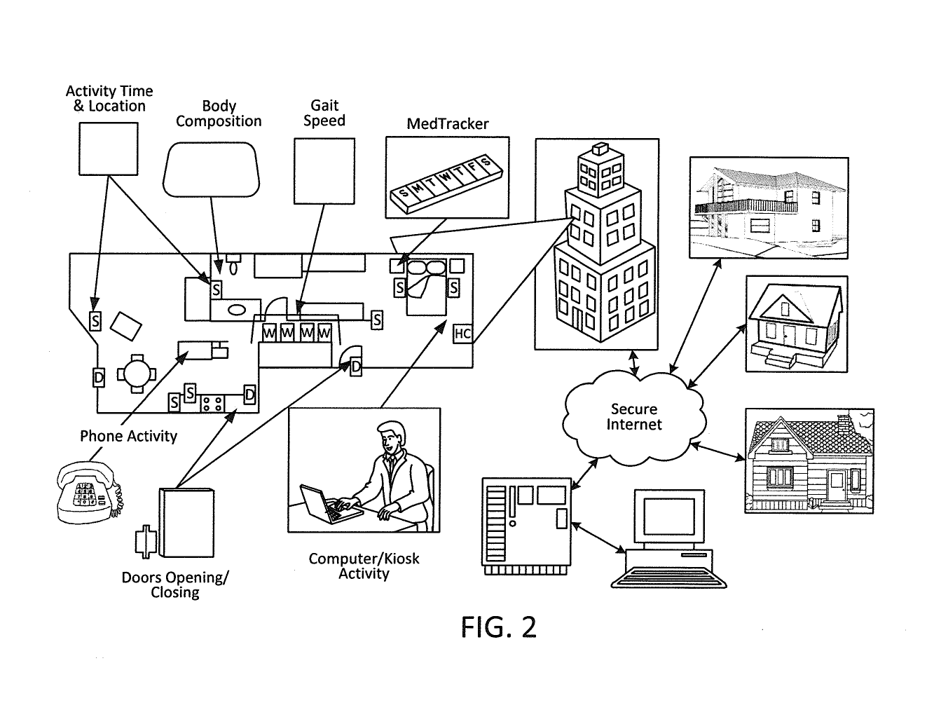

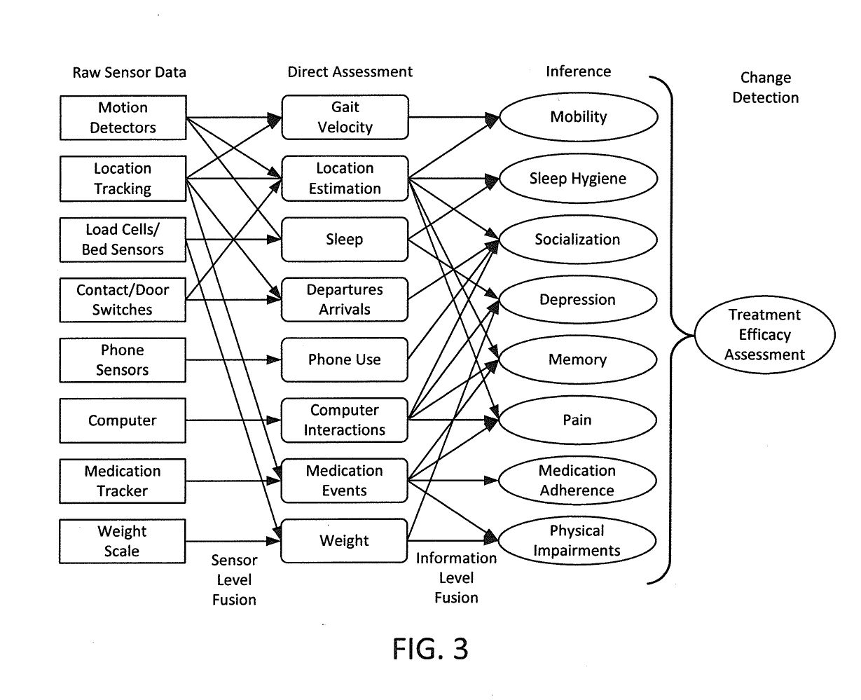

FIG. 2 is a diagram of a distributed community model of in-home functional assessment of patients. FIG. 2 illustrates the process of in-home monitoring to functional assessment. It shows pictorially the process from placement in the home of sensors that measure different aspects of behavior and/or activity, the secure internet connection that transmits the collected data from a local computer that receives the sensor outputs to servers behind a firewall, to a processor on which analysis and health inferences are made. One step not explicitly shown here is the processing of the raw data from the database to derived metrics (e.g., sensor firings to walking speed estimates) and another is the derived data to inference about functional outcomes (e.g., slowing in walking speed suggests cognitive decline). This aspect is illustrated in FIG. 3.

FIG. 3 is a data flow diagram showing acquisition of raw sensor data, direct assessment, top-level inferences and change detection for key functional domains/capability clusters that can be objectively assessed on a near-continuous basis in connection with the present invention. FIG. 3 shows how in-home sensed data is acquired, assessed and processed for inference about key functional domains/capability clusters. For clarity, not all possible vectors are displayed. FIG. 3 shows the data/process flow from raw sensor data collected in the home through “top-level” inferences about health. This process includes the sensor fusion/algorithm level, the derived metrics (Direct Assessment), fusion of derived metrics (Information Fusion), and the inferences about health and/or quality-of-life outcomes.

FIG. 3 shows graphically an example implementation of a method according to the invention for conducting a clinical trial of a medical treatment with respect to a human patient. The left-most column shows a variety of sensors for substantially continuously monitoring various objective functions of the patient and producing raw sensor output data signals. The objective functions can include objective physical functions and/or objective behavioral functions of the patient. Further, the continuously monitored objective physical or behavioral functions of the patient include a substantially continuous measure of one or more of the physical or behavioral functions of the patient, a substantially continuous measure of intra-patient variations of the one or more of the physical or behavioral functions of the patient, or combinations of both.

The terms “continuous,” “continuously” and “substantially continuously” take into account that different sensors operate with different frequencies. For example, motion detectors, location tracking devices and load cells/bed sensors operate all the time (“real time”) and provide output signals or data that are digitally continuous (i.e., converted to digital from analog signals). They will capture and output data for at least as long as a subject is present. A motion detector can also sense absence of motion in a given area, and output that data as well. A bed sensor can output real time data indicating presence of a subject, and additionally can detect movement on, off and while in bed, and output corresponding data. Other sensors, such as door contact switches, phone sensors, patient's computer, medication tracker and weight scale, typically operate sporadically, when actuated by the subject. They may still be considered continuous because they are usable at any time during a day or night and will provide corresponding output data. All of this raw sensor output data is sent to a local computer, where it may be stored in memory for periodic reporting, for example at least daily, preferably nightly. As described below, this reporting would ordinarily be to a server for storage in memory and further analysis.

Referring to the second column of FIG. 3, the monitored sensor data are directly assessed to transform the raw data into various objective physiologic and behavioral functional measurements. This transformation can be done on the local computer, or on the server. From the direct assessment, inferences can then be drawn to further transform the information to quality of life measurements, each of which can be inferred from multiple various objective physiologic and behavioral functional measurements, as shown by the vectors to the third column of FIG. 3. Among other things, the objective functions of the patient can be compared against a baseline set of data for the monitored objective functions for either the same patient or for a set of patients (a set of peers). Examples of such comparisons are described below.

The comparisons and other analyses can be used to detect a trend of deviation between the one or more of the objective functions of the patient and the baseline set of data. The deviation can include a change in a mean or median of the monitored objective functions or a change in a variance of the monitored objective functions, or both. The deviation can be with respect to baseline data for the same patient, which can be useful in detecting his or her individual change of some aspect of health or quality of life status, or with respect to baseline data for peers, such as mean or median characteristics for the peer group.

The trend of deviation can then be correlated with an application or nonapplication of the medical treatment with respect to the patient. This correlation can be used to assess the efficacy of the treatment. In some instances it can also help determine or assess side effects of the treatment. The medical treatment will ordinarily include a course of medication that is subject of a clinical study but can include any other form of clinical intervention. Examples include but are not limited to a pain medication or a medication for treatment of Parkinson's disease or MCI/Alzheimer's disease.

The clinical trial is usually applied to a sample set of a plurality of patients, which in the prior art is typically very large and extends over multiple years. In accordance with the invention, the sample set preferably has a size selected based on intra-individual distributions of daily activities based on the substantially continuously monitored objective physical functions of the patient over a sample period of time, which for many purposes, such as determining efficacy of a treatment, can be much shorter than the number of years for conventional trials. The sample set size can also selected based in part on a treatment effect size to be measured. The sample set size can be as much as an order of magnitude less than a sample set size derived from a series of monthly to annual measures of patient-subjective reports of patient functions. The sample period of time for the substantially continuous monitoring of objective physical functions of the patient can be as little as a fraction of a year.

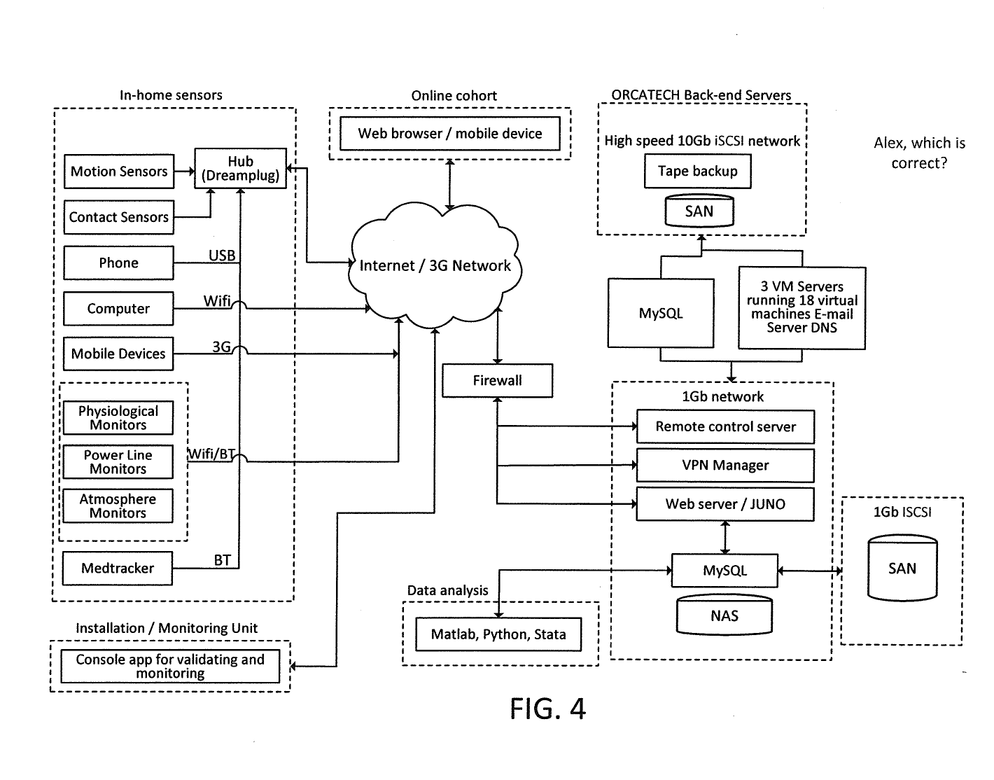

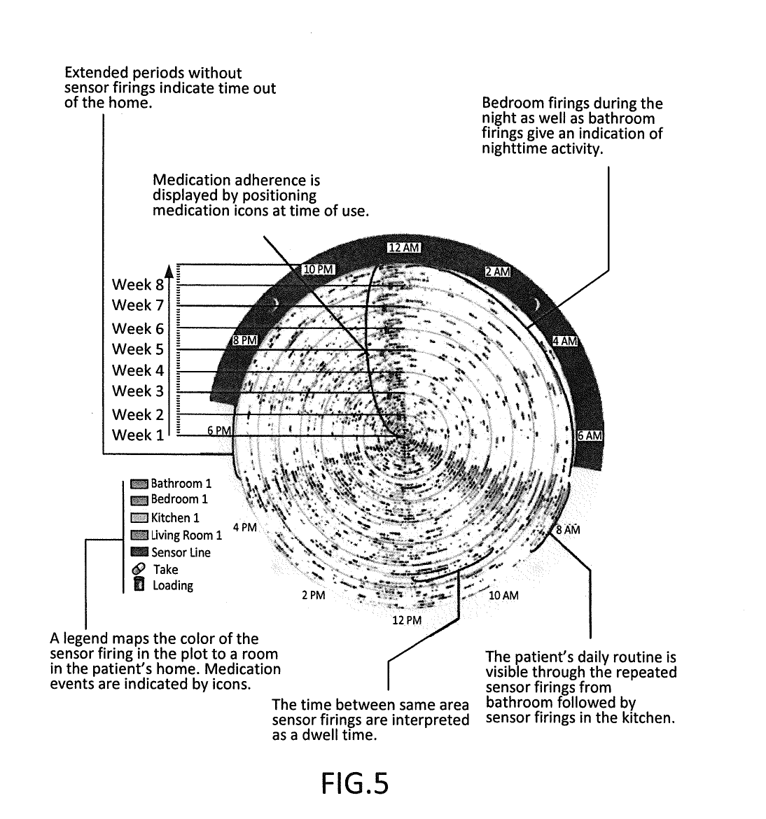

FIG. 4 is a block diagram of a hardware system for implementing the present invention. A system for conducting a clinical trial with respect to human patients comprises a plurality of monitoring devices or in-home sensors arranged in a living space for each human patient, the monitoring devices selected to monitor one or more objective functions of each human patient and to provide corresponding output data for the objective functions continuously, at least daily over a period of time.

FIG. 4 is a block diagram of an example of such a system. Other known systems, such as those shown and described in U.S. Pat. No. 8,810,388 (Jacobs et al.) and U.S. Pat. No. 8,894,577 (Reed et al.), can be adapted to implement the present invention. Further information about some aspects of the in-home system used herein appears in J. Kaye et al., “Unobtrusive measurement of daily computer use to detect mild cognitive impairment” Alzheimer's and Dementia (2014, 10(1):10-7), and J. Kaye et al., “Intelligent Systems for Assessing Aging Changes: Home-based. Unobtrusive, and Continuous Assessment of Aging” The Journals of Gerontology, Series B, Psychological Sciences and Social Science (2011), 66B(s1): i180-i190.

The output data is collected by a local computer having one or more inputs receiving the output data from the monitoring devices. That computer, or another computer such as a server (or both), includes a storage device for storing the received output data over the period of time. The storage device or other memory has a memory device including a database storing a baseline set of data for the objective functions for the patient or a set of patients.

A processor in the local computer or in the server, or distributed between them, is operative to receive, assess and compare the stored output data to the baseline set of data. Preferably, the local computer communicates the received output data via an Internet or wireless connection to a server which preferably includes the processor and the database of baseline data.

The processor is further operative to detect a trend of deviation between the stored output data and the baseline set of data and to correlate the trend of deviation with an application or non-application of a medical treatment with respect to the patient. The processor further operates to transform, assess and draw inferences from the output data from the in-home sensors in the manner described above in connection with FIG. 3.

FIGS. 5-9 show data from various sources and locations relating patterns of activity connected to a “health event.” The spiral plot is a 24-hour clock representing 8 weeks of continuous data for one individual. At the top of the clock is midnight; at the bottom is noon. Each concentric blue circle outward represents 2 weeks of time. The colors of the dots represent firings of sensors by location.

FIG. 5 is a 24/7 spiral plot showing daily patterns over an 8-week interval of objective functions of a patient monitored substantially continuously in-home around the clock. The plot includes a color key and symbols indicating patient location and activities and captions indicating and describing features of the plot.

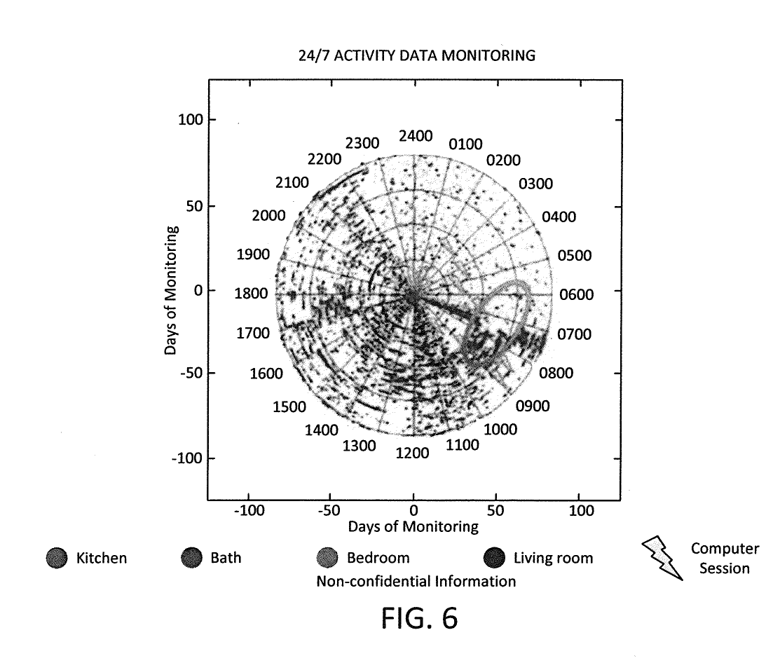

FIG. 6 is a plot similar to FIG. 5 showing a time interval in which the sensors detected changes in activities indicated in the key. The oval in FIG. 6 represents a two-week period of a norovirus outbreak resulting in a noticeable change in usual activity pattern.

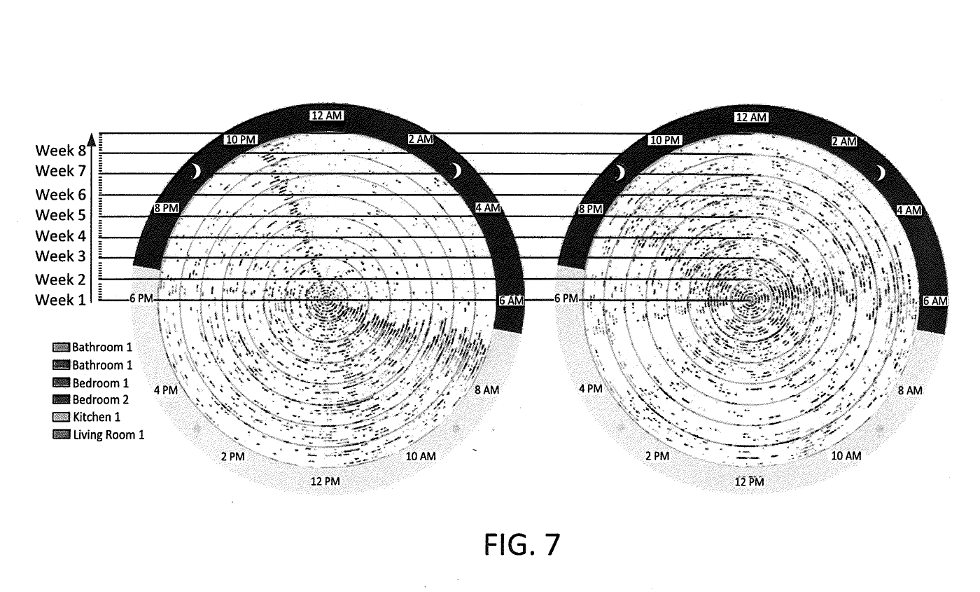

FIG. 7 shows two plots like FIG. 6 for a particular patient P taken over two different time durations. The left plot shows normal or baseline activities in a first 8-week period and the second plot for patient P during an 8-week interval about 18 months later, at which time the patient was diagnosed with Parkinson's disease. FIG. 7 shows that the in-home assessment platform detected key changes associated with the onset of Parkinson's disease (PD). In particular, the large number of red dots between 8 pm and 6 am on the right panel (compared to the left) shows severely disturbed sleep patterns associated with PD. Of note, prior to the diagnosis of PD, bed-time was consistently later and rise-time was consistently earlier. With the onset of PD, the patient was up much more frequently during the night and was less active during the day. Similar comparisons between the panels show that the participant stopped making meals in the apartment and left home more often (presumably to eat) in the right panel.

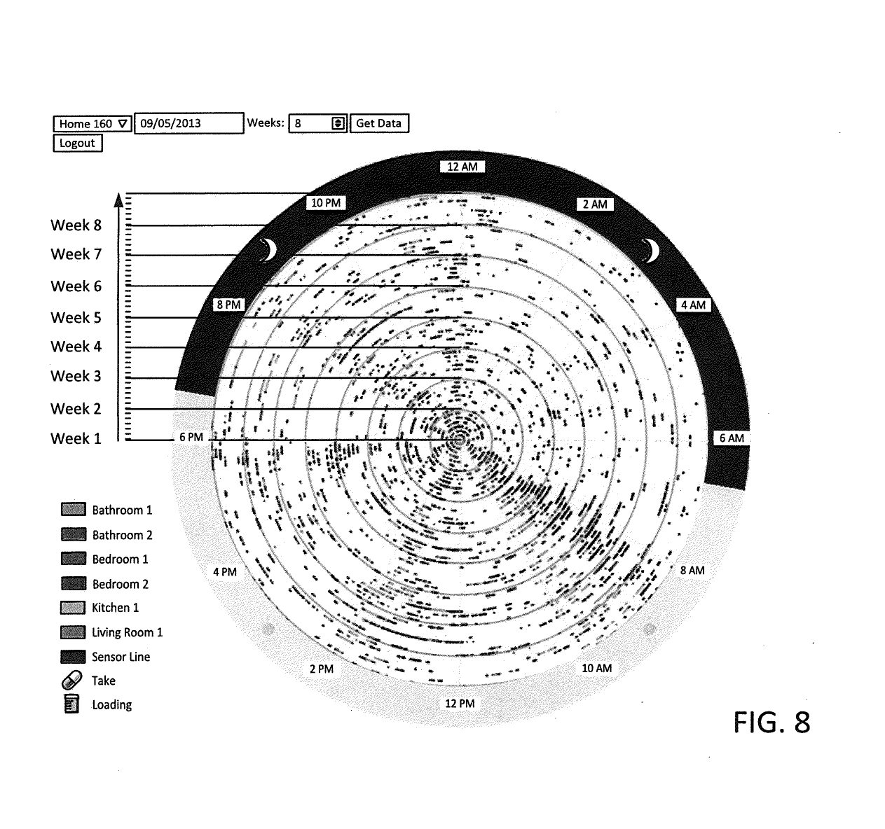

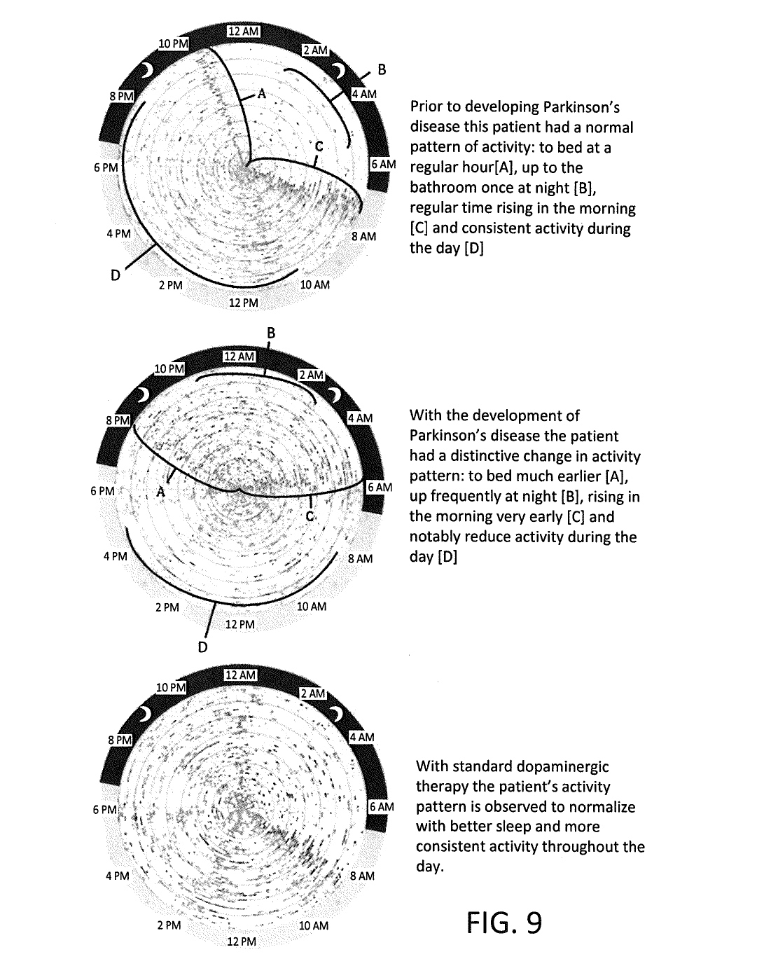

FIG. 8 is a plot similar to those of FIG. 7 showing a time interval after commencement of treatment of patient P for Parkinson's disease. This plot shows changes of various objective functions that are further described in FIG. 9.

FIG. 9 shows the activity plots of FIGS. 7 and 8 annotated with indications of significant features and changes in the patient's functions corresponding to changes from healthy to ill and back to improved health and function with treatment.

Prior to developing Parkinson's disease, as shown in the first panel of FIG. 7, this patient had a normal pattern of activity: to bed at a regular hour [A], up to the bathroom once at night [B], regular time rising in the morning [C] and consistent activity during the day [D].

With the development of Parkinson's disease, as shown in the second panel of FIG. 7, the patient had a distinctive change in activity pattern: to bed much earlier [A], up frequently at night [B], rising in the morning very early [C] and notably reduced activity during the day [D].

With standard dopaminergic therapy, as shown in FIG. 8, the patient's activity pattern is observed to normalize with better sleep and more consistent activity throughout the day.

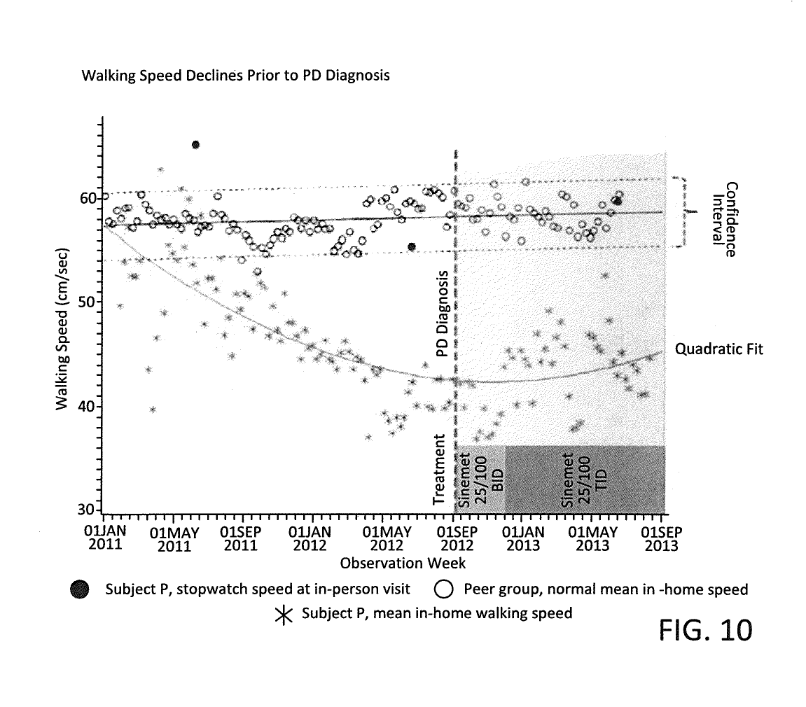

FIG. 10 is a plot of in-home walking speed of patient P (indicated by *) compared to peer group normal mean in-home walking speed (indicated by open circle symbols) and to patient P's walking speed at in-person clinical visits (shown by a few solid circles). FIG. 10 shows a very important case study result. It shows the decline in walking speed associated with Parkinson's disease (left of PD diagnosis line) followed by the arrest of decline and subsequent improvement in walking speed due to medication, all detected by the assessment platform. In particular, this plot suggests that a PD therapy could be assessed with the platform of FIGS. 3 and 4 by monitoring in-home walking speed.

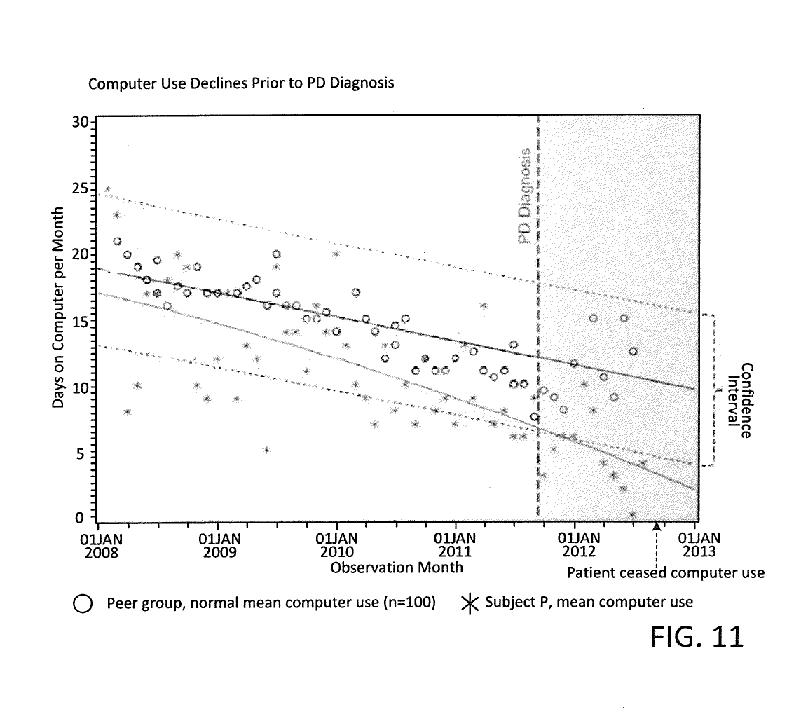

FIG. 11 is a plot of in-home computer usage of patient P compared to peer group normal mean in-home computer usage. The plot of FIG. 11 goes well with the plot of FIG. 10 for showing the detection of functional declines (computer use) associated with PD prior to diagnosis. Since the subject appeared to stop using the computer (and there is not data through September 2013 as in the walking speed plot), it is unclear whether monitoring computer use could help detect a positive effect of a PD drug (that is, if she/he doesn't begin using the computer after taking medication, we would not be able to monitor any improvements in use patterns due to a drug). This emphasizes the value of the multi-domain functional assessment provided by the platform.

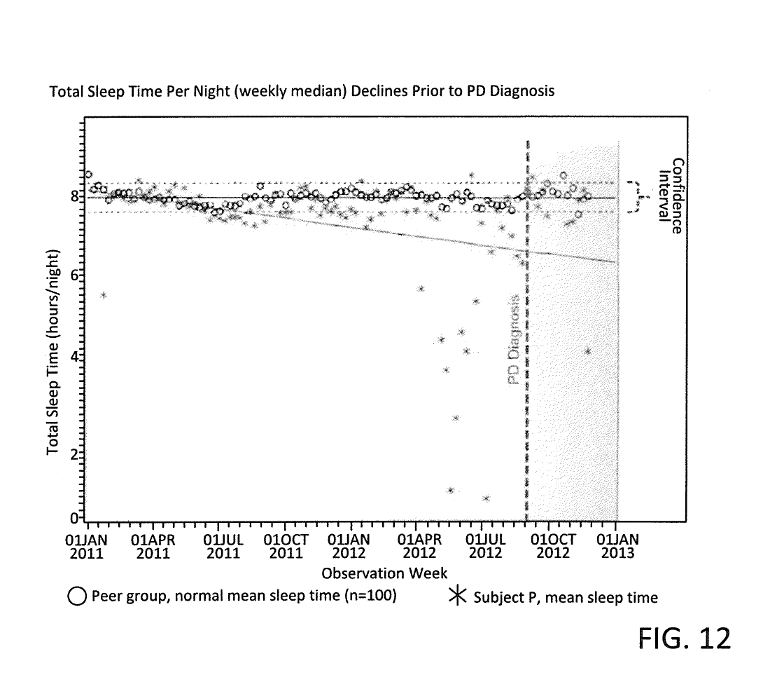

FIG. 12 is a plot of mean sleep time of patient P compared to peer group mean sleep time. The plot of FIG. 12 goes well with the PD plots of FIGS. 10 and 11 for showing the detection of functional declines (decreased sleep quality) associated with PD prior to diagnosis. Since the subject appeared to stop using the computer (and there is not data through September 2013 as in the walking speed plot), it is unclear whether monitoring mean sleep time could help detect a positive effect of a PD drug, but it seems especially promising in view of the improvement in sleep patterns shown between FIGS. 7 and 8.

The plots of FIGS. 10, 11 and 12 display the patients' changes based on one variable at a time. While one variable alone might be strongly indicative of changes in some aspect of the patient's health status, the combination of such variables is likely to be a reliable indicator of changes.

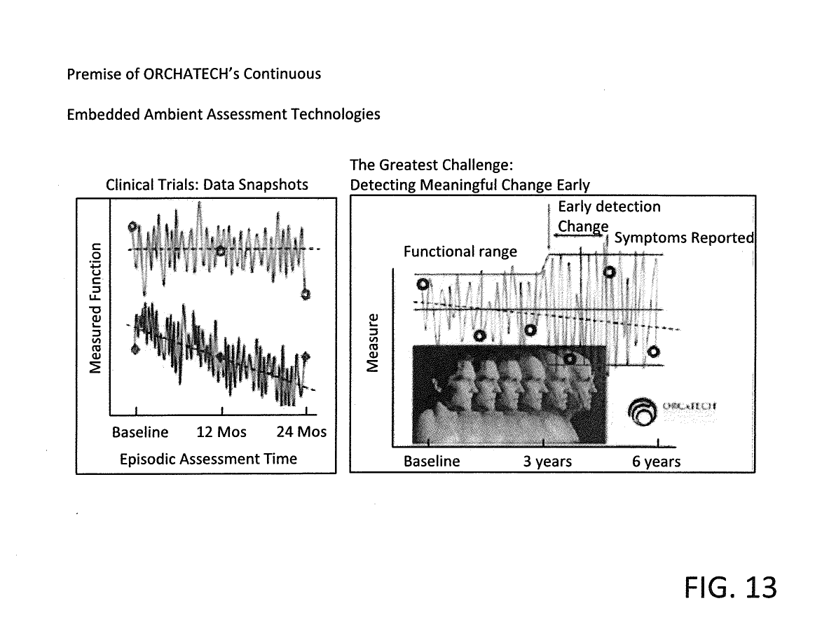

FIG. 13 are graphs illustrating two types of changes that are analyzed in the present invention, the first graph showing changes in mean or median measured function and the second graph showing change of variance of the measured function.

FIG. 13 is an excellent demonstration of why objective and frequent measurement is capable of detecting key changes (e.g. trial outcomes such as pain level) earlier and with less time than those using traditional assessment. The circle and diamond symbols indicate data points obtained using conventional periodic assessment of a subject in contrast to continuously monitored unobtrusive measurement of function. The left plot also shows how traditional assessment can be misleading because of “aliasing” in the signal (under-sampling). The left panel shows this for a trend and the right panel shows this for variability around the trend line. The right panel shows change of functional range (increased variation) which cannot be detected by traditional sparse periodic sampling.

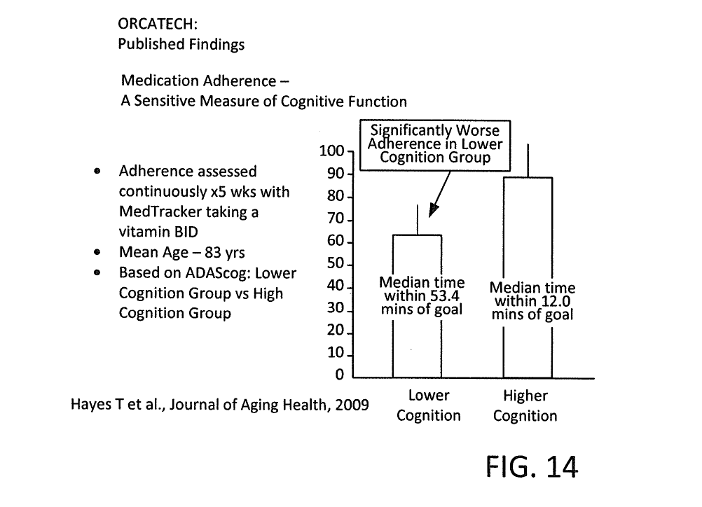

FIG. 14 is a graph of medication adherence as a measure of differences in cognitive function. FIG. 14 shows how unobtrusive and (almost) continuous monitoring of medication management can detect subtle differences in cognitive function.

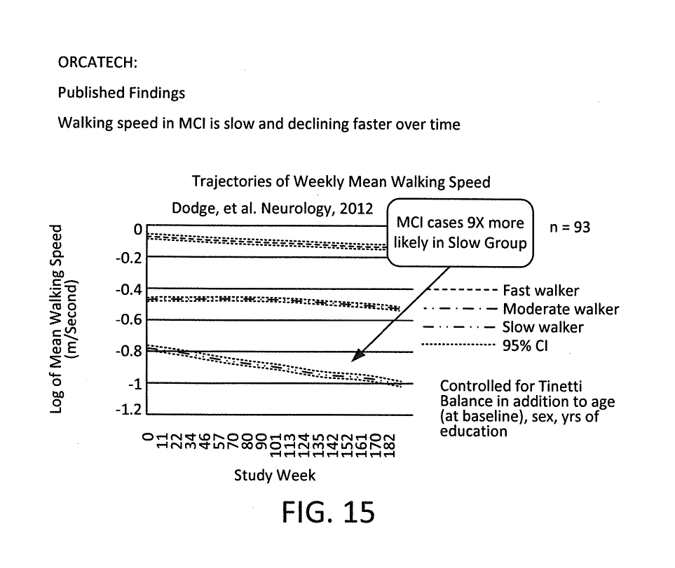

FIG. 15 is a graph of walking speed as a measure of change in mild cognitive impairment. FIG. 15 shows that slower in-home walking speed is associated with mild cognitive impairment (MCI), suggesting that monitoring walking speed can help with early detection of the disease.

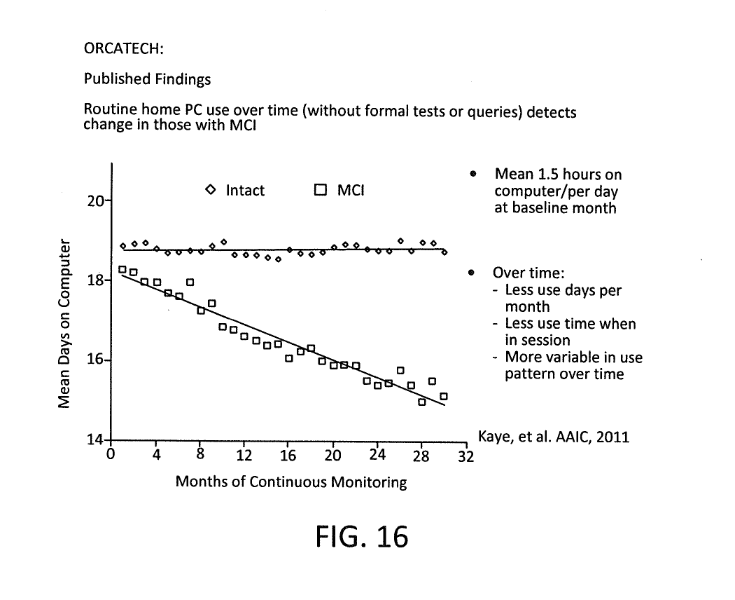

FIG. 16 is a graph of home personal computer usage as a measure of change in mild cognitive impairment. FIG. 16 shows that monitoring computer use is important in assessing cognitive decline (and thus potential improvements in cognitive decline from a pharmaceutical).

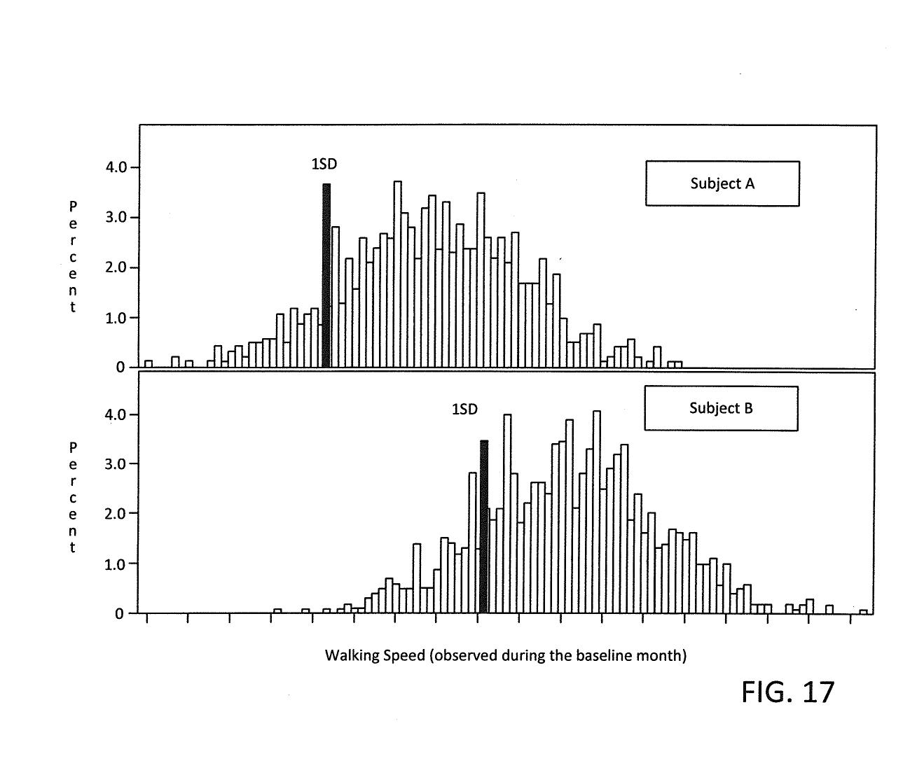

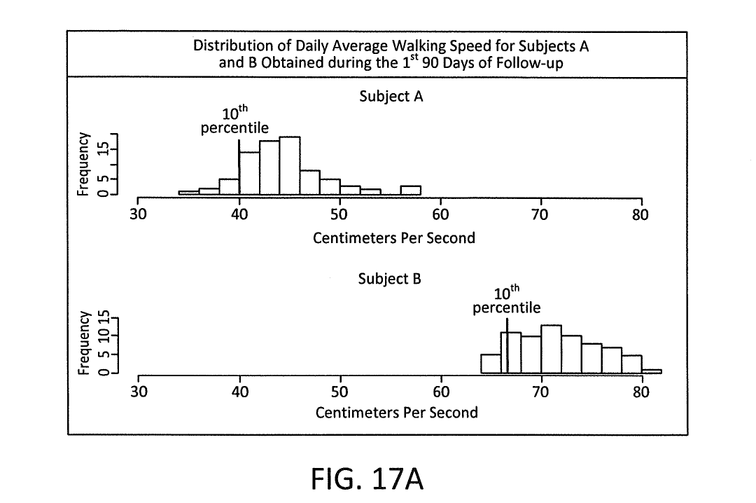

FIG. 17 shows two graphs for two hypothetical persons comparing their walking speeds and showing their respective variances in walking speed at a first standard deviation.

FIG. 17 shows the importance of using intra-individual distributions of activity functions. Data on walking speed is shown for two individuals, unobtrusively measured continuously at home over a period of time (baseline month). Comparing them, the data sets have a different mean or median and slightly different variances. Averaging them together would obscure those differences, and would also obscure changes for one subject over a longer period of time. The intra-individual distributions shown in FIG. 17 can be used as a baseline for comparisons of later-acquired data likewise unobtrusively measured continuously at home, which will enable one to see shifts in walking speed. Similar comparisons can be made as to other functional activities of each subject. Such comparisons are not made, and really cannot be made, using conventional self-report and infrequently-collected measurements in a clinical setting.

FIG. 17A is an example of real walking measurements comparing two patients. According to the baseline (first 90 days) walking speed histograms, subject A (id=7621) was much slower initially than subject B (id=11012). However, subject A was only slower than his/her subject specific baseline 10th percentile during 11% of the later weekly follow-ups, and subject B was slower than his/her subject specific baseline 10th percentile during 79% of the weekly follow-ups. This indicates that although subject A was slower at the beginning, his/her walking speed was stable while there was an obvious slowing trend for subject B. The group's 10th percentile based on the first three months of data is 39.3. Subject B was never slower than the group 10th percentile threshold during the entire follow up period. Therefore the fact that subject B got much slower over time was not reflected by using the group specific threshold.

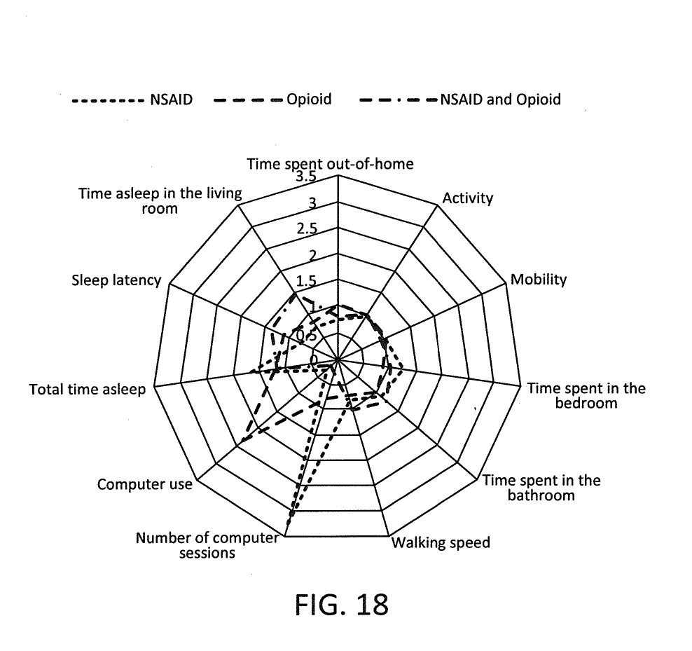

FIG. 18 is a radar graph in which each radial spoke represents a different objective measure of a person's activities or capabilities, further showing examples of how these measures are affected by various drugs.

FIG. 18 shows predicted drug class effects on objectively-determinable functions of human subjects, which is useful as a baseline for clinical tests and comparisons of new pain drugs. It should be noted NSAID drugs tend to promote total time asleep and number of computer sessions of subjects while opioids tend to increase duration of computer use relative to NSAIDs alone or in combination with NSAIDs. Conversely, the combination of NSAID and opioid increases sleep latency and time asleep in the living room relative to those drugs individually.

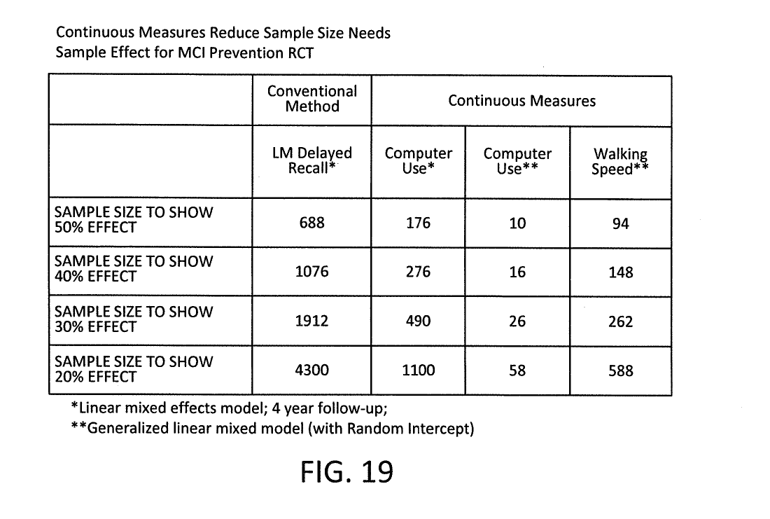

FIG. 19 is a table showing an example of how in-home continuous measures of objective activities reduces sample sizes needed to assess mild cognitive impairment.

FIG. 19 compares sample size required using the conventional method mentioned above in the first column with statistical measures of sample sizes required using various continuously monitored measures of the set of subjects and individual-specific distributions (as opposed to group norms) of participant data, in connection with determining clinical trial efficacy in the treatment of Alzheimer's disease and treating potential dementia or mild cognitive impairment (MCI). The measures selected for continuous measurement in this study are computer use and walking, which have been recognized as tied to MCI. These results of statistical analysis show two things. First, the show that continuously monitored measures enable use of much smaller sample sizes. Second, they show that sample sizes can be selected for different percentage effects of a medical treatment and that continuous measures enable much smaller sample sizes for each percentage effect. Not shown in FIG. 19 is that in-home continuous measures can enable clinical testing to be conducted in a shorter time. Conventional measures may require several years to obtain sufficient data to measure efficacy of a treatment, while continuous measures enable much shorter times to obtain statistically significant data.

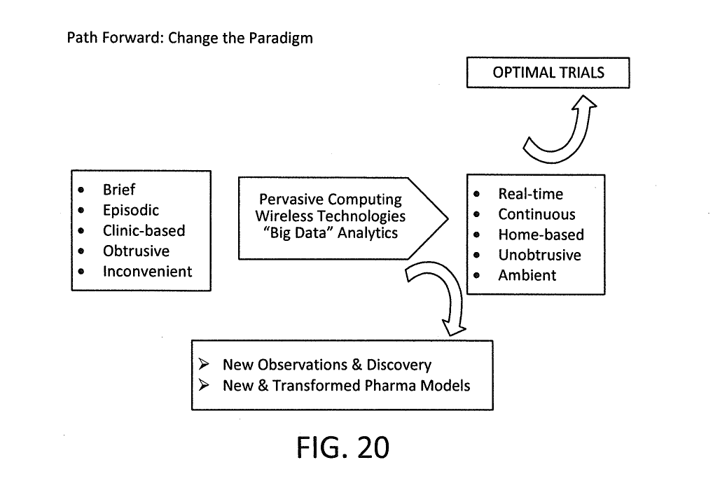

FIG. 20 is a block diagram comparing the conventional method for conducting clinical trials with the method of the present invention.

FIG. 20 is illustrative of the change of paradigm in the present invention, from the conventional way clinical trials have been conducted, which is episodic, clinic-based and obtrusive, relying heavily on subjects' reports and performance on request, to a new way based on real time or continuous home-based monitoring of objectively-observable activities and behaviors, which is unobtrusive and less likely to bias the subjects' behavior and resulting data. The new approach also enables much more reliable tracking of intra-individual changes. The result is much more efficient and effective clinical trials, which can cost much less and take less time to determine whether a given treatment is effective or not.

Having described and illustrated the principles of the invention in a preferred embodiment thereof, it should be apparent that the invention can be modified in arrangement and detail without departing from such principles. I claim all modifications and variation coming within the spirit and scope of the following claims.

1. A method for conducting a clinical trial of a medical treatment with respect to at least one human patient, comprising:
substantially continuously monitoring one or more objective functions of the patient;
comparing the monitored objective functions of the patient against a baseline set of data for the monitored objective functions for the patient or a set of patients;
detecting a trend of deviation between the one or more monitored objective functions of the patient and the baseline set of data; and
correlating the trend of deviation with an application or nonapplication of the medical treatment with respect to the patient.

2. A method according to claim 1 in which the medical treatment includes at least one of a medication and a clinical intervention.

3. A method according to claim 1 in which the objective functions include objective physical functions of the patient.

4. A method according to claim 1 in which the objective functions include objective behavioral functions of the patient.

5. A method according to claim 1 in which the clinical trial is applied to a sample set of a plurality of patients, the sample set having a size selected based on intra-individual distributions of daily activities based on the substantially continuously monitored objective physical functions of the patient over a sample period of time.

6. A method according to claim 5 in which the sample set size is selected based in part on a treatment effect size to be measured.

7. A method according to claim 5 in which the sample set size is about one order of magnitude less than a sample set size derived from a series of monthly to annual measures of patient-subjective reports of patient functions.

8. A method according to claim 5 in which the sample period of time for the substantially continuously monitoring of objective physical functions of the patient to determine sample size is a fraction of a year.

9. A method according to claim 1 in which the monitored objective physical functions of the patient include a substantially continuous in-home measure of one of the physical functions of the patient and a substantially in-home continuous measure of intra-patient variations of the one of the physical functions of the patient.

10. A method according to claim 2 in which the medication is a pain medication.

11. A method according to claim 2 in which the medication is a medication for treatment of Parkinson's disease.

12. A method according to claim 2 in which the medication is a medication for treatment of Alzheimer's disease or a related disorder.

13. A method according to claim 1 in which the deviation includes a change in a mean or median of the monitored objective functions.

14. A method according to claim 1 in which the deviation includes a change in a variance of the monitored objective functions.

15. A system for conducting a clinical trial with respect to human patients, the system comprising:
a plurality of monitoring devices arranged in a living space for each human patient, the monitoring devices selected to monitor one or more objective functions of each human patient and to provide corresponding output data for the objective functions at least daily over a period of time;
a computer having one or more inputs receiving the output data from the monitoring devices;
a storage device for storing the received output data over the period of time;
a database storing a baseline set of data for the objective functions for the patient or a set of patients; and
a processor operative to compare the stored output data to the baseline set of data;
the processor further operative to detect a trend of deviation between the stored output data and the baseline set of data and to correlate the trend of deviation with an application or non-application of a medical treatment with respect to the patient.

16. A system according to claim 15 in which the monitoring devices include one or more sensors to monitor objective physical functions of the patient and one or more sensors to monitor objective behavioral functions of the patient.

17. A system according to claim 15 in which the deviation includes at least one of a change in mean or median of the objective functions of each patient and a change in variance of the objective functions of each patient.

18. A system according to claim 15 in which the computer communicates the received output data to a server which includes the processor.
